(19) United States
(12) Patent Application Publication
(10) Pub. No.: US 2026/0009290 A1
(43) Pub. Date: Jan. 8, 2026

(54) EASILY RETRACTABLE AND EXTENDABLE ROLLER BLIND

(71) Applicant: HANGZHOU GIPUTA CLOTHING CO., LTD., Hangzhou (CN)

(72) Inventors: Yu Pan, Hangzhou (CN); Michael Alexander Mayer, Hangzhou (CN)

(73) Assignee: HANGZHOU GIPUTA CLOTHING CO., LTD., Hangzhou (CN)

(21) Appl. No.: 19/247,305

(22) Filed: Jun. 24, 2025

(30) Foreign Application Priority Data
Jul. 5, 2024 (CN) 2024215812326

(51) Int. Cl. E06B 9/44

(52) U.S. Cl. CPC E06B 9/44

(57) ABSTRACT

An easily retractable and extendable roller blind including: a roller blind body, including a curtain fabric; a curtain fabric fixing assembly, including a deformable member connected to a bottom end of the curtain fabric, wherein when the curtain fabric is rolled up to a predetermined position, both ends of the deformable member are fixedly connected to form the closed loop structure, the closed loop structure fixing the posture of the curtain fabric. When the deformable member is rolled up to a preset position, it forms a closed-loop structure. The present invention enables manual retraction and extension without the need for a pull cord mechanism, ensuring safe operation, applicability, low manufacturing costs, and simple, quick operation.

### FIELD OF THE INVENTION

The invention relates to a roller blind, and more particularly to an easily retractable and extendable roller blind.

### BACKGROUND OF THE INVENTION

Roller blind products usually rely on the rotation of the roller tube to drive the retraction and extension of the curtain fabric. There are various ways to drive the rotation of the roller tube in the market, including rope/bead-pull operation, lever operation, spring-driven mechanism, and motor-driven mechanism. All these methods can control the retraction and extension of the curtain fabric. However, their parts and structures are relatively numerous and complex. The rope/bead-pull operation has potential safety hazards for children, as it is easy to get caught around the neck, and it is also inconvenient to use. The production and manufacturing costs of other forms are relatively high. There are two installation methods for roller blinds in the market: drilling installation and non-drilling installation. Among them, non-drilling installation is becoming increasingly popular. However, there is still room for optimization of non-drilling installation components to make them more convenient to use.

In view of the problems existing in some roller blind products in the current market, such as potential safety hazards for children, high production and manufacturing costs, and inconvenience of use, a simple-to-operate retractable roller blind is provided.

### SUMMARY OF THE INVENTION

The present invention is directed to providing an easily retractable and extendable roller blind, aiming to solve the technical problem of inconvenience in use associated with existing roller blinds.

To achieve the foregoing objective, the present invention adopts the following technical solution:

An easily retractable and extendable roller blind comprising:
a roller blind body, comprising a curtain fabric;
a curtain fabric fixing assembly, comprising a deformable member connected to a bottom end of the curtain fabric, wherein when the curtain fabric is rolled up to a predetermined position, both ends of the deformable member are fixedly connected to form the closed loop structure, the closed loop structure fixing the posture of the curtain fabric.

Further, the deformable member comprises:
a first deformable body, connected to the bottom end of the curtain fabric, the first connection end of the first deformable body extending along one side of the curtain fabric;
a second deformable body, connected to the bottom end of the curtain fabric, the second connection end of the second deformable body extending along the other side of the curtain fabric;
when the curtain fabric is rolled up, the first deformable body and the second deformable body move upward with the rolling center of the curtain fabric; when the curtain fabric reaches the predetermined rolling height, the first and second connection ends respectively fold back around the edge of the curtain fabric from each side and connect with each other to form the closed loop structure.

Further, the curtain fabric fixing assembly further comprises a fixing member connected to the deformable member, and the fixing member connects and fixes both ends of the deformable member through one or more of bonding, magnetic connection, plug-in connection, or snap-fit connection.

Further, the fixing member is one or more of hook-and-loop fastener, fastening buckle, magnetic clasp, or button.

Further, the roller blind assembly further comprises a beam component connected to the curtain fabric, and a mounting assembly connected to the beam component; the mounting assembly comprises:
a support base, connected to the beam component;
a support block, slidably connected to the support base;
an anti-slip structure, arranged on the support block;
a status adjusting element, movably connected to the support block, the status adjusting element being capable of driving relative movement between the support block and the support base, and defining the connection posture between the support block and the support base.

Further, the support base is provided with a positioning slot configured to limit the relative movement direction between the support block and the support base; and the support block is provided with a sliding block adapted to the positioning groove.

Further, the deformable member is a flexible member.

Further, the deformable member is connected and fixed to the bottom end of the curtain fabric in a transverse orientation.

The beneficial effects of the easily retractable and extendable roller blind provided by the present utility model are as follows: Compared with the prior art, the easily retractable and extendable roller blind of the present utility model enables the deformable member to form a closed loop structure when the curtain fabric is rolled up to a predetermined position. This closed loop structure is fitted around the curtain fabric, thereby establishing a stable connection state between the closed loop structure and the curtain fabric, which in turn locks the curtain fabric at the predetermined rolled-up position. When it is necessary to extend the curtain fabric, the connection between the closed loop structure and the curtain fabric can simply be released. This roller blind does not require a cord-pulling mechanism and can be manually retracted and extended, offering advantages such as safety in use, broad applicability, and low manufacturing cost. Its simple and quick operation greatly enhances user convenience.

### BRIEF DESCRIPTION OF THE DRAWINGS

By reading the detailed description provided with reference to the drawings of non-limiting embodiment, other features, objectives, and advantages of the invention will become more apparent:

FIG. 1 is a schematic structural view of an easily retractable and extendable roller blind according to an embodiment of the present invention;

FIG. 2 is an exploded structural view of the easily retractable and extendable roller blind according to an embodiment of the present invention;

FIG. 3 is a schematic structural view of a mounting assembly used in the easily retractable and extendable roller blind according to an embodiment of the present invention;

FIG. 4 is a first schematic structural view of a support base used in FIG. 3;

FIG. 5 is a second schematic structural view of the support base used in FIG. 3;

FIG. 6 is a schematic structural view of a support block used in FIG. 3;

FIG. 7 is a schematic structural view of a locking nut used in FIG. 3;

FIG. 8 is a schematic structural view of a curtain fabric fixing assembly used in the easily retractable and extendable roller blind according to an embodiment of the present invention;

FIG. 9 is a schematic view showing the usage state of the curtain fabric fixing assembly used in the easily retractable and extendable roller blind according to an embodiment of the present invention;

FIG. 10 is a schematic structural view of another curtain fabric fixing assembly used in the easily retractable and extendable roller blind according to an embodiment of the present invention;

FIG. 11 is a schematic structural view of yet another curtain fabric fixing assembly used in the easily retractable and extendable roller blind according to an embodiment of the present invention.

### DESCRIPTION OF REFERENCE NUMERALS

1—Curtain Fabric;
2—Beam Assembly;
3—Mounting Assembly;
31—Support Base;
311—Positioning Groove;
312—Circular Hole;
313—Slotted Hole;
314—Mounting Hole;
32—Support Block;
321—Sliding Block;
322—Receiving Groove;
323—Threaded Rod;
33—Anti-slip Structure;
34—Status Adjusting Element;
4—Curtain Fabric Fixing Assembly;
41—Deformable Member;
411—First Deformable Body;
412—Second Deformable Body;
42—Fixing Member.

### DETAILED DESCRIPTION OF THE PREFERRED EMBODIMENTS

In order to make the technical problems to be solved, the technical solutions, and the beneficial effects of the present invention more clear and understandable, the present invention is further described in detail below with reference to the accompanying drawings and embodiments. It should be understood that the specific embodiments described herein are merely intended to illustrate the present invention and are not intended to limit its scope.

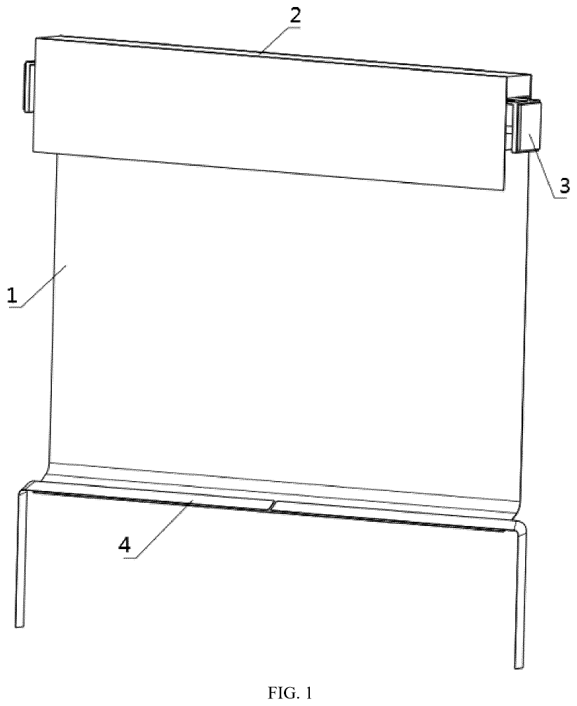

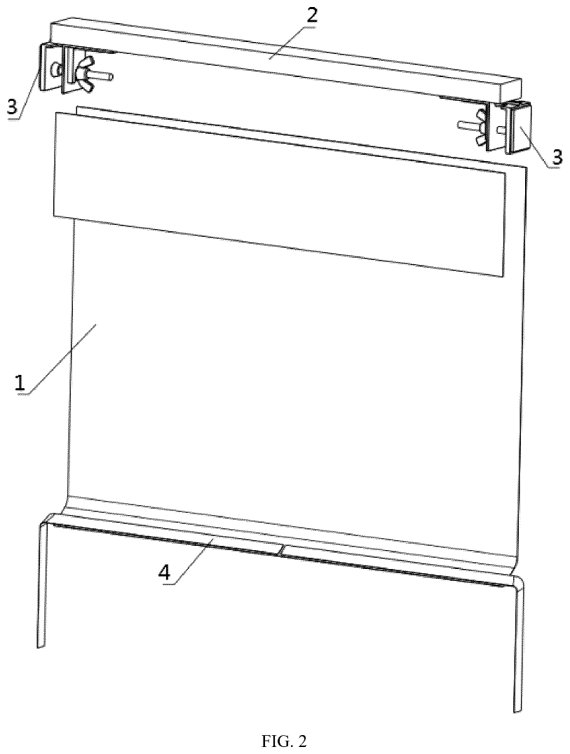

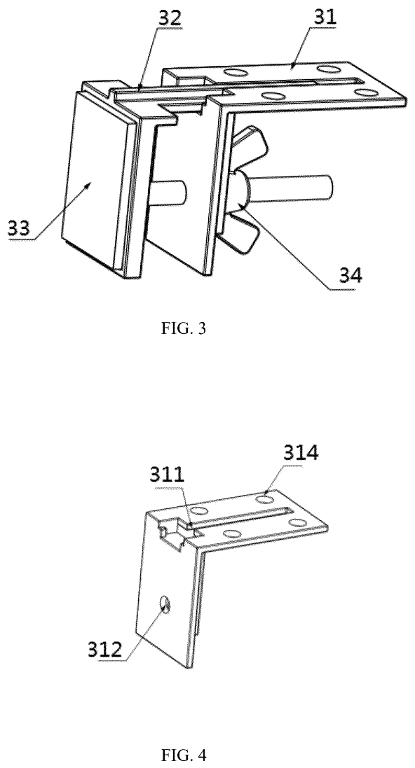

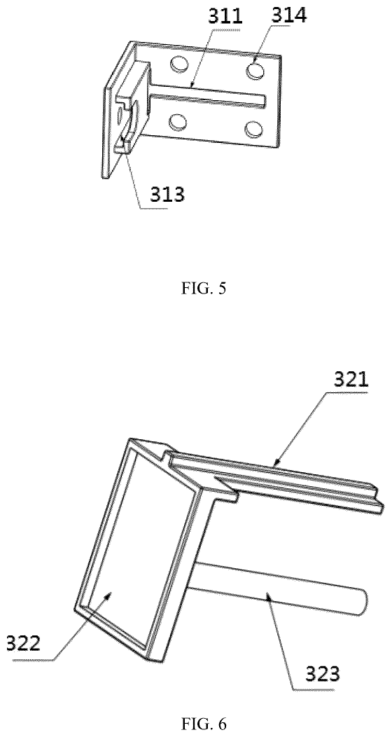

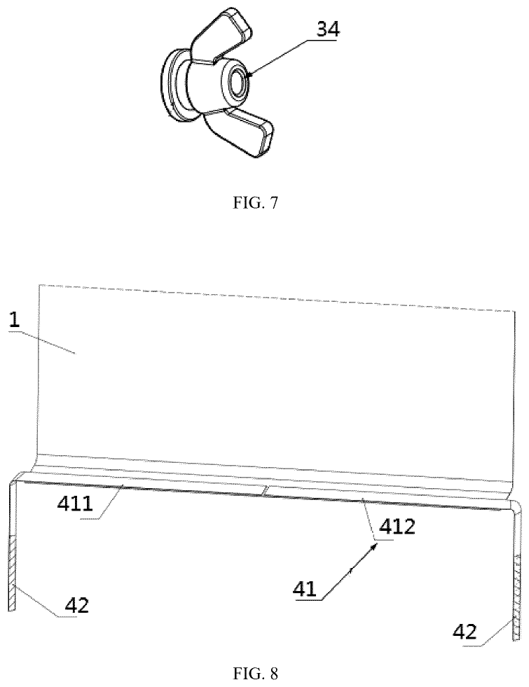

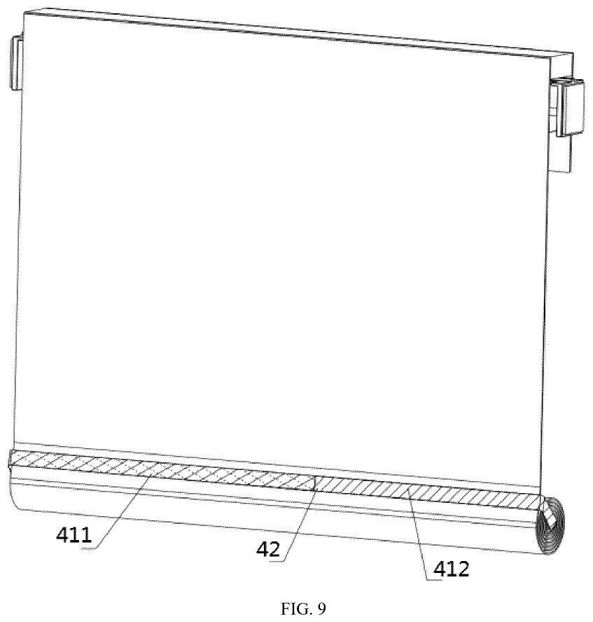

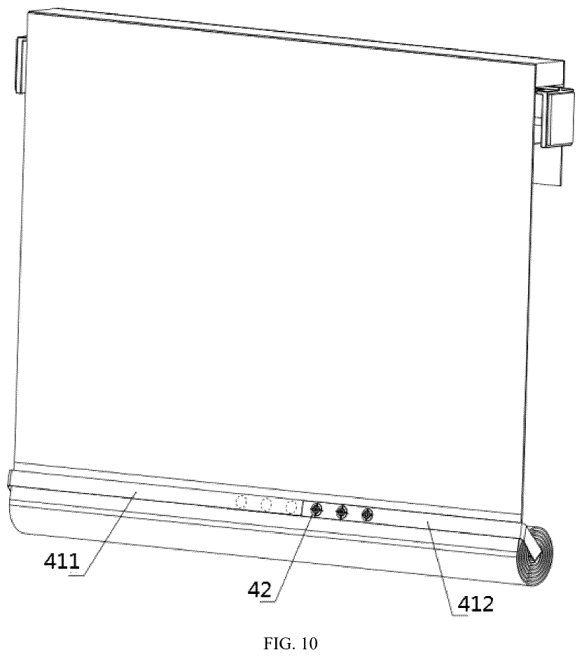

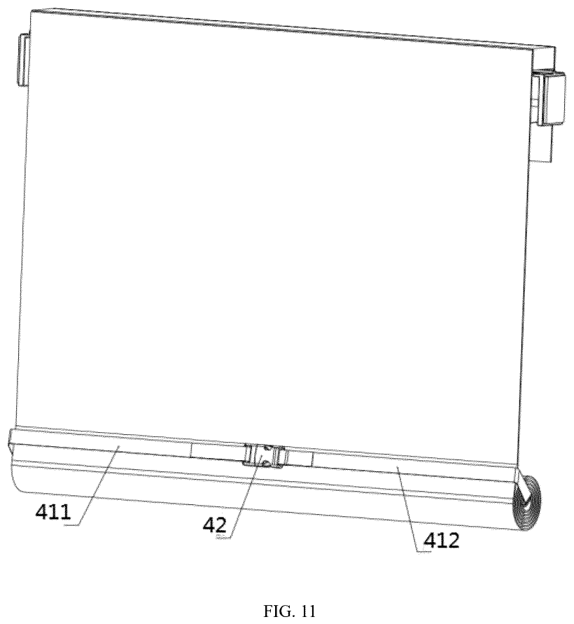

Please refer to FIGS. 1 to 11. The present invention provides an easily retractable and extendable roller blind, which is described as follows. The roller blind comprises a roller blind assembly and a curtain fabric fixing assembly 4. The roller blind assembly includes a curtain fabric 1. The curtain fabric fixing assembly 4 comprises a deformable member 41 connected to the bottom end of the curtain fabric 1. When the curtain fabric 1 is rolled up to a predetermined position, both ends of the deformable member 41 are connected and fixed to form a closed ring structure. This closed ring structure stabilizes the posture of the curtain fabric 1.

Compared with the prior art, the easily retractable and extendable roller blind provided by the present invention features a deformable member 41 that forms a closed ring structure when the curtain fabric 1 is rolled up to a predetermined position. This closed ring structure is looped around the curtain fabric 1, allowing it to remain in a stable connected state with the fabric, thereby achieving locking of the curtain fabric 1 when it is in the rolled-up position. When the curtain fabric 1 needs to be extended, the connection between the closed ring structure and the curtain fabric 1 can simply be released. The roller blind does not require a pull cord mechanism and can be manually retracted and extended, offering safe usage, strong applicability, and low production and manufacturing costs. It is easy and quick to operate, greatly enhancing user convenience. When the curtain fabric 1 is rolled up, the first deformable body 411 and the second deformable body 412 move upward together with the rolling center of the curtain fabric 1. After the curtain fabric 1 reaches a predetermined rolled-up height, the first connecting end and the second connecting end fold back around the edges of the curtain fabric from either side and are connected together to form a closed ring structure.

As a specific embodiment of the present invention, and with reference to FIGS. 1 to 11, the deformable member 41 comprises a first deformable body 411 and a second deformable body 412. The first deformable body 411 is connected to the bottom end of the curtain fabric 1, and a first connecting end of the first deformable body 411 extends along one side of the curtain fabric 1. The second deformable body 412 is also connected to the bottom end of the curtain fabric 1, and a second connecting end of the second deformable body 412 extends along the opposite side of the curtain fabric 1. In this embodiment, the first connecting end and the second connecting end may be fixedly connected by means of tying. That is, both the first and second connecting ends are configured as strap-like structures. When the closed ring structure is to be formed, the first and second connecting ends are tied together to form a slipknot structure. When the curtain fabric 1 needs to be extended, the slipknot structure can simply be untied.

In any feasible embodiment, the curtain fabric fixing assembly 4 further comprises a fixing member 42 connected to the deformable member 41. The fixing member 42 enables the two ends of the deformable member 41 to be connected and secured by one or more of the following means: adhesion, magnetic connection, insertion, or snap-fit.

In the present embodiment, the fixing member 42 is one or more of the following: hook-and-loop fastener, fastening buckle, magnetic clasp, or button.

In any feasible embodiment, the deformable member 41 is a flexible component. The deformable member 41 is fixedly connected to the bottom end of the curtain fabric 1 in a transverse orientation. Specifically, the first deformable body 411 is fixed at the bottom of the curtain fabric 1 and is a flexible component. One end of the first deformable body 411 extends transversely along one side of the curtain fabric 1. The extension length of the first deformable body 411 is greater than half of the width of the curtain fabric 1. When the curtain fabric 1 is rolled upward, the first deformable body 411 moves upward along with the rolling center of the curtain fabric 1. After reaching the desired rolled-up height, the extended end of the first deformable body 411 can fold back around the edge of the curtain fabric 1 from one side and be connected to the second deformable body 412. The first deformable body 411 and the second deformable body 412 are connected by the fixing member 42, forming a closed loop together with the curtain fabric 1 and thereby securing it in place. The second deformable body 412, which is also a flexible component, is fixed to the bottom of the curtain fabric 1. One end of the second deformable body 412 extends in the direction opposite to the extension direction of the first deformable body 411. When the curtain fabric 1 is rolled upward, the second deformable body 412 also moves upward along with the rolling center of the curtain fabric 1. After reaching the desired rolled-up height, the extended end of the second deformable body 412 can fold back around the edge of the curtain fabric 1 from one side and be connected to the first deformable body 411 by the fixing member 42, thereby forming a closed loop and securing the rolled-up portion of the curtain fabric 1. The function of the fixing member 42 is to enable a secure connection between the first deformable body 411 and the second deformable body 412 when needed. The fixing member 42 may be mounted directly on the first deformable body 411 and/or the second deformable body 412, or may be configured as an independent component.

### Example 1

The first deformable body 411 is a flexible webbing, which is transversely fixed below the curtain fabric 1 by means such as adhesive bonding or riveting. One end of the first deformable body 411 extends outward transversely toward one side of the curtain fabric 1. When the curtain fabric 1 is rolled upward, the first deformable body 411 moves upward together with the rolling center of the curtain fabric 1. Upon reaching the desired position, the extended end folds back from the rolled curtain fabric 1 side edge and is connected to the second deformable body 412 on the opposite side through the fixing member 42, thereby securing the curtain fabric 1 at the rolled-up position. Example 1: The first deformable body 411 is a flexible webbing, which is transversely fixed below the curtain fabric 1 by means such as adhesive bonding or riveting. One end of the first deformable body 411 extends outward transversely toward one side of the curtain fabric 1. When the curtain fabric 1 is rolled upward, the first deformable body 411 moves upward together with the rolling center of the curtain fabric 1. Upon reaching the desired position, the extended end folds back from the rolled curtain fabric 1 side edge and is connected to the second deformable body 412 on the opposite side through the fixing member 42, thereby securing the curtain fabric 1 at the rolled-up position. The fixing member 42 is a hook-and-loop fastener, including both hook and loop components. One component is mounted on one surface (front or back) of the first deformable body 411, and the corresponding component is mounted on the surface of the second deformable body 412 facing the first deformable body 411. The first deformable body 411 and the second deformable body 412 can thus be connected and closed by means of the hook-and-loop fastener.

### Example 2

As described in Example 1, the structure of the deformable member 41 is the same. Only the fixing member 42 differs; therefore, other parts are not repeated here.

The fixing member 42 is a snap fastener, composed of part A and part B. Part A and part B can be fastened to each other. Multiple instances of part A and part B are evenly distributed on the first deformable body 411 and the second deformable body 412, respectively, and arranged opposite each other. Part A and part B can be freely paired and fastened to adjust the connection distance between the first deformable body 411 and the second deformable body 412. The snap fastener may specifically be a magnetic snap.

### Example 3

As described in Example 1, the structure of the deformable member 41 is the same. Only the fixing member 42 differs; therefore, other parts are not repeated here.

The fixing member 42 is a buckle, consisting of a plug and a socket. The plug and socket are fixed respectively at the extended ends of the first deformable body 411 and the second deformable body 412. At least one fixed end of either the plug or socket can be adjusted relative to the first deformable body 411 and the second deformable body 412 to regulate the connection distance between the first deformable body 411 and the second deformable body 412.

In any feasible embodiment, the first deformable body 411 and the second deformable body 412 are integrally formed, i.e., the deformable member 41 is of an elastic strap structure. The first deformable body 411 and the second deformable body 412 respectively constitute parts of the elastic strap structure. The two ends of the elastic strap structure are fixedly connected to the two ends of the bottom edge of the fabric 1.

According to one possible embodiment of the present invention, and with reference to FIGS. 1 through 10, the roller blind assembly further comprises a beam assembly 2 connected to the fabric 1, and a mounting assembly 3 connected to the beam assembly 2. It should be noted that the fabric 1 and the beam assembly 2 pertain to the prior art and are not the focus of the present invention; thus, a detailed description thereof is omitted for conciseness. The mounting assembly 3 comprises a support base 31, a support block 32, an anti-slip structure 33, and a status adjusting element 34. The support base 31 is connected to the beam assembly 2; the support block 32 is slidably connected to the support base 31; the anti-slip structure 33 is disposed on the support block 32; and the status adjusting element 34 is movably connected to the support block 32. The status adjusting element 34 is configured to drive relative motion between the support block 32 and the support base 31, and to define or restrict the positional relationship between the support block 32 and the support base 31.

In this embodiment, the support base 31 is provided with a positioning groove 311 configured to constrain the direction of relative movement between the support block 32 and the support base 31; the support block 32 is provided with a sliding block 321 adapted to the positioning groove 311.

The support base 31 is a bracket fixedly mounted at one end of the beam assembly 2 and has an overall L-shaped structure. A plurality of mounting holes 314 are formed on the lateral end face of the support base 31, allowing it to be fastened to the beam assembly 2 by screws.

A positioning groove 311 is formed on the lateral end face of the support base 31 and is configured to cooperate with a positioning rib (i.e., sliding block 321) provided on the support block 32, thereby enabling the support block 32 to perform horizontal sliding motion relative to the support base 31. A circular hole 312 is formed on the vertical end face of the support base 31 to allow a threaded rod mounted on the support block 32 to pass there through. A slotted hole 313 is formed on the inner side of the vertical end face of the support base 31 for positioning the status adjusting element 34, thereby preventing horizontal movement of the status adjusting element 34 relative to the support base 31. The support block 32 also has an L-shaped structure and is configured to adjust the distance from the support surface and to provide expansion-based clamping. A positioning rib (i.e., sliding block 321) is provided on the lateral end face of the support block 32 to cooperate with the positioning groove 311 and enable horizontal movement of the support block 32 along the positioning groove 311. A receiving groove 322 is formed on the outer side of the vertical end face of the support block 32 for accommodating an anti-slip structure 33. A threaded rod 323 is arranged on the inner side of the vertical end face of the support block 32. The threaded rod 323 passes through the circular hole 312 of the support base 31 and engages with a locking nut, i.e., the status adjusting element 34. The support block 32 is thereby driven to move relative to the support base 31 by tightening or loosening the locking nut (i.e., status adjusting element 34). The locking nut (i.e., status adjusting element 34) is mounted on the support base 31 and provided with an annular base that fits into the slotted hole 313 for positioning purposes. This configuration allows adjustment of the relative displacement between the support block 32 and the support base 31, thereby enabling the support block 32 to either press tightly against or disengage from the support surface. The locking nut is a wing nut. The anti-slip structure 33 is mounted within the groove of the support block 32 and is configured to contact the support surface, thereby preventing relative slippage between the mounting assembly and the support surface after expansion-based clamping. The anti-slip structure 33 is a silicone pad. The mounting assembly 3, when in contact with the support surface and tightened via expansion, enables the roller blind to be mounted within a window or door frame without the need for drilling. This structure offers the advantages of ease of use, stable cooperation between components, and reduced likelihood of separation.

The above descriptions are merely preferred embodiments of the present invention and are not intended to limit the scope of the present invention. Any modifications, equivalent substitutions, or improvements made within the spirit and principle of the present invention shall fall within the scope of protection of the present invention.

1. An easily retractable and extendable roller blind comprising:
a roller blind body, comprising a curtain fabric;
a curtain fabric fixing assembly, comprising a deformable member connected to a bottom end of the curtain fabric, wherein when the curtain fabric is rolled up to a predetermined position, both ends of the deformable member are fixedly connected to form the closed loop structure, the closed loop structure fixing the posture of the curtain fabric.

2. The easily retractable and extendable roller blind according to claim 1, wherein:
the deformable member comprises:
a first deformable body, connected to the bottom end of the curtain fabric, the first connection end of the first deformable body extending along one side of the curtain fabric;
a second deformable body, connected to the bottom end of the curtain fabric, the second connection end of the second deformable body extending along the other side of the curtain fabric;
when the curtain fabric is rolled up, the first deformable body and the second deformable body move upward with the rolling center of the curtain fabric; when the curtain fabric reaches the predetermined rolling height, the first and second connection ends respectively fold back around the edge of the curtain fabric from each side and connect with each other to form the closed loop structure.

3. The easily retractable and extendable roller blind according to claim 1, wherein:
the curtain fabric fixing assembly further comprises a fixing member connected to the deformable member, and the fixing member connects and fixes both ends of the deformable member through one or more of bonding, magnetic connection, plug-in connection, or snap-fit connection.

4. The easily retractable and extendable roller blind according to claim 3, wherein:
the fixing member is one or more of hook-and-loop fastener, fastening buckle, magnetic clasp, or button.

5. The easily retractable and extendable roller blind according to claim 1, wherein:
the roller blind assembly further comprises a beam component connected to the curtain fabric, and a mounting assembly connected to the beam component; the mounting assembly comprises:
a support base, connected to the beam component;
a support block, slidably connected to the support base;
a anti-slip structure, arranged on the support block;
a status adjusting element, movably connected to the support block, the status adjusting element being capable of driving relative movement between the support block and the support base, and defining the connection posture between the support block and the support base.

6. The easily retractable and extendable roller blind according to claim 5, wherein:
the support base is provided with a positioning slot configured to limit the relative movement direction between the support block and the support base; and the support block is provided with a sliding block adapted to the positioning groove.

7. The easily retractable and extendable roller blind according to claim 1, wherein:
the deformable member is a flexible member.

8. The easily retractable and extendable roller blind according to claim 1, wherein:
the deformable member is connected and fixed to the bottom end of the curtain fabric in a transverse orientation.

9. The easily retractable and extendable roller blind according to claim 2, wherein:
the curtain fabric fixing assembly further comprises a fixing member connected to the deformable member, and the fixing member connects and fixes both ends of the deformable member through one or more of bonding, magnetic connection, plug-in connection, or snap-fit connection.
